(19) United States
(12) Patent Application Publication
(10) Pub. No.: US 2008/0232110 A1
(43) Pub. Date: Sep. 25, 2008

(54) Illuminating device having enhanced light gathering effect

(76) Inventor: Ming-Tsai Wang, Kaohsiung County (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/726,021

(22) Filed: Mar. 20, 2007

(51) Int. Cl. F21V 13/04

(52) U.S. Cl. 362/308

(57) ABSTRACT

An illuminating device includes a main body, at least one light emitting member, a non-spherical light permeable lens, and a retaining ring. Thus, the convex face of the light permeable lens gathers the light emitted from the light emitting member to provide a light gathering effect to the light emitting member, thereby enhancing the lighting effect of the light emitting member. In addition, the reflective face of the main body reflects the light emitted from the light emitting member toward the light permeable lens to enhance the lighting effect of the light emitting member.

### BACKGROUND OF THE INVENTION

1. Field of the Invention

The present invention relates to an illuminating device and, more particularly, to an illuminating device that emits light outwardly to provide an illuminating effect.

2. Description of the Related Art

A conventional illuminating device, such as a flashlight, comprises a housing having a distal end provided with a light outlet portion, a light emitting member mounted in the housing to emit light outwardly from the light outlet portion of the housing, a battery mounted in the housing to supply an electric power to the light emitting member, and a control switch mounted in the housing and connected between the battery and the light emitting member to control an electrical connection between the battery and the light emitting member. However, the light emitting member has a poor light gathering effect so that the light emitted from the light emitting member is easily diffused, thereby decreasing the lighting effect of the light emitting member.

### BRIEF SUMMARY OF THE INVENTION

In accordance with the present invention, there is provided an illuminating device, comprising illuminating device, comprising a main body having an inner wall formed with a substantially cone-shaped concave reflective face having a longitudinal depth ranged between 18 and 22 millimeters, at least one light emitting member mounted in the main body and located at a central portion of the reflective face of the main body to emit light outwardly from the main body, and a non-spherical light permeable lens mounted on the main body and including a plane and a non-spherical convex face so that the light emitted from the light emitting member in turn passes through the plane of the light permeable lens and the convex face of the light permeable lens and is emitted outwardly from the main body.

The primary objective of the present invention is to provide an illuminating device having an enhanced light gathering effect.

Another objective of the present invention is to provide an illuminating device, wherein the convex face of the light permeable lens gathers the light emitted from the light emitting-member to provide a light gathering effect to the light emitting member, thereby enhancing the lighting effect of the light emitting member.

A further objective of the present invention is to provide an illuminating device, wherein the reflective face of the main body reflects the light emitted from the light emitting member toward the light permeable lens to enhance the lighting effect of the light emitting member.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of an illuminating device in accordance with the preferred embodiment of the present invention.

FIG. 2 is an exploded perspective view of the illuminating device as shown in FIG. 1.

FIG. 3 is a front cross-sectional view of the illuminating device as shown in FIG. 1.

FIG. 4 is a schematic perspective operational view of the illuminating device as shown in FIG. 1.

FIG. 5 is another schematic perspective operational view of the illuminating device as shown in FIG. 1.

### DETAILED DESCRIPTION OF THE INVENTION

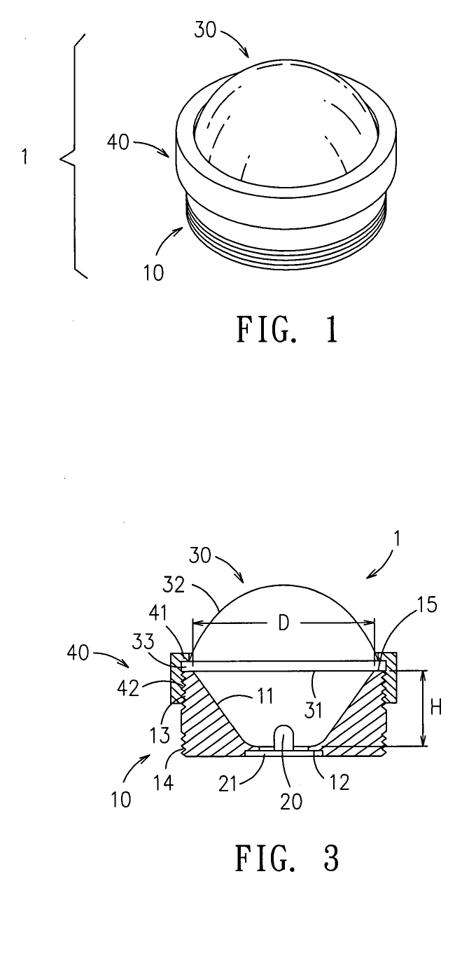

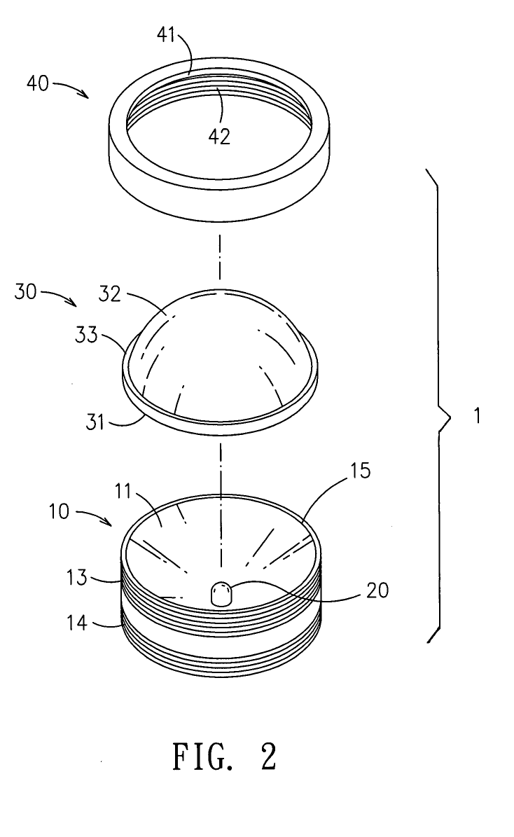

Referring to the drawings and initially to FIGS. 1-3, an illuminating device 1 in accordance with the preferred embodiment of the present invention comprises a main body 10 having an inner wall formed with a substantially cone-shaped concave reflective face 11 having a longitudinal depth “H” ranged between 18 and 22 millimeters, at least one light emitting member 20 (such as light emitting diode) mounted in the main body 10 and located at a central portion of the reflective face 11 of the main body 10 to emit light outwardly from the main body 10, and a non-spherical light permeable lens 30 mounted on the main body 10 and including a plane 31 and a non-spherical convex face 32 so that the light emitted from the light emitting member 20 in turn passes through the plane 31 of the light permeable lens 30 and the convex face 32 of the light permeable lens 30 and is emitted outwardly from the main body 10.

The main body 10 is made of aluminum material. The reflective face 11 of the main body 10 is enclosed around the light emitting member 20 to reflect the light emitted from the light emitting member 20 toward the plane 31 of the light permeable lens 30. The reflective face 11 of the main body 10 has a maximum diameter “D” ranged between 48 and 52 millimeters. The main body 10 has a first end formed with an outer thread 13 and a second end formed with an outer threading 14. The main body 10 has a peripheral wall formed with an annular resting portion 15 located at a top of the reflective face 11.

The illuminating device further comprises a circuit board 21 mounted in the main body 10 and electrically connected to the light emitting member 20. The main body 10 has a bottom formed with a recessed receiving portion 12 to receive the circuit board 21 which is fully hidden in the receiving portion 12 of the main body 10.

The illuminating device further comprises a retaining ring 40 mounted on the main body 10 and rested on the light permeable lens 30 to retain the light permeable lens 30 between the retaining ring 40 and the main body 10. The retaining ring 40 has an inner wall formed with an inner thread 42 screwed onto the outer thread 13 of the main body 10 so that the retaining ring 40 is detachably mounted on the main body 10. The retaining ring 40 has an end face formed with a radially and inwardly extending annular retaining flange 41 rested on the light permeable lens 30 so that the light permeable lens 30 is detachably located between the retaining ring 40 and the main body 10.

The light permeable lens 30 is detachably mounted on the main body 10 and is located in front of the light emitting member 20. The light permeable lens 30 has a periphery formed with a radially and outwardly extending annular limit flange 33 located between the plane 31 and the convex face 32 and clamped between the retaining flange 41 of the retaining ring 40 and the resting portion 15 of the main body 10 so that the light permeable lens 30 is clamped between the retaining ring 40 and the main body 10. The convex face 32 of the light permeable lens 30 protrudes outwardly from the retaining ring 40. The plane 31 of the light permeable lens 30 is located between the light emitting member 20 and the convex face 32 of the light permeable lens 30.

In operation, referring to FIGS. 1-3, the light emitted from the light emitting member 20 in turn passes through the plane 31 of the light permeable lens 30 and the convex face 32 of the light permeable lens 30 and is emitted outwardly from the main body 10 to provide an illuminating effect. At this time, the reflective face 11 of the main body 10 reflects the light emitted from the light emitting member 20 toward the light permeable lens 30 to enhance the lighting effect of the light emitting member 20. In addition, the convex face 32 of the light permeable lens 30 gathers the light emitted from the light emitting member 20 to provide a light gathering effect to the light emitting member 20.

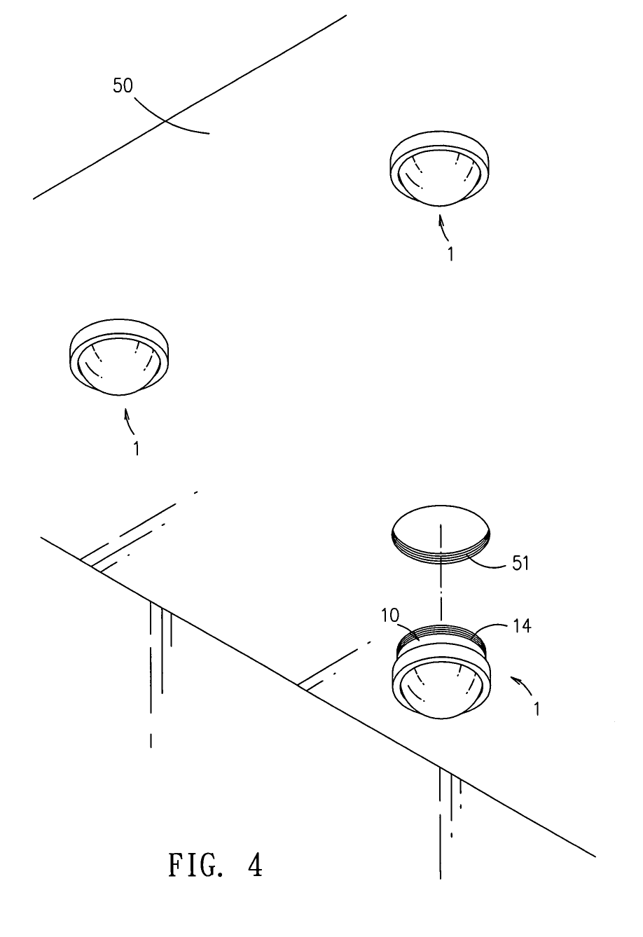

Referring to FIG. 4, when the illuminating device 1 is mounted on a ceiling 50, the outer threading 14 of the main body 10 is screwed into a screw bore 51 of the ceiling 50 to attach the illuminating device 1 to the ceiling 50. Thus, the illuminating device 1 is mounted on the ceiling 50 to provide an illuminating effect.

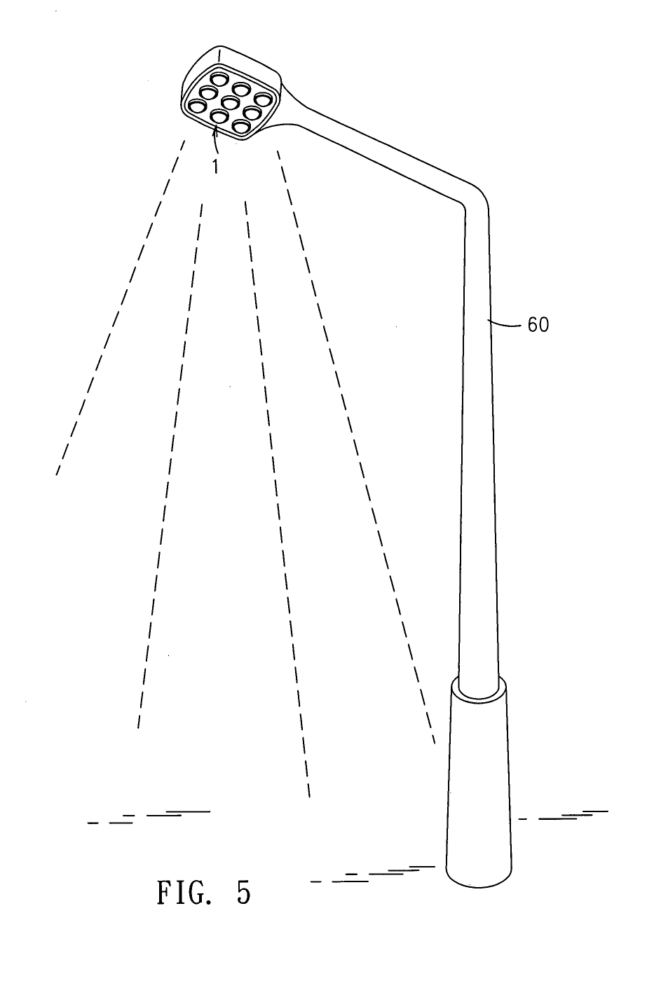

Referring to FIG. 5, the illuminating device 1 is mounted on a lamp 60 to provide an illuminating effect.

Accordingly, the convex face 32 of the light permeable lens 30 gathers the light emitted from the light emitting member 20 to provide a light gathering effect to the light emitting member 20, thereby enhancing the lighting effect of the light emitting member 20. In addition, the reflective face 11 of the main body 10 reflects the light emitted from the light emitting member 20 toward the light permeable lens 30 to enhance the lighting effect of the light emitting member 20.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An illuminating device, comprising:
a main body having an inner wall formed with a substantially cone-shaped concave reflective face having a longitudinal depth ranged between 18 and 22 millimeters;
at least one light emitting member mounted in the main body and located at a central portion of the reflective face of the main body to emit light outwardly from the main body;
a non-spherical light permeable lens mounted on the main body and including a plane and a non-spherical convex face so that the light emitted from the light emitting member in turn passes through the plane of the light permeable lens and the convex face of the light permeable lens and is emitted outwardly from the main body.

2. The illuminating device in accordance with claim 1, wherein the reflective face of the main body has a maximum diameter ranged between 48 and 52 millimeters.

3. The illuminating device in accordance with claim 1, wherein the main body is made of aluminum material.

4. The illuminating device in accordance with claim 1, wherein the reflective face of the main body is enclosed around the light emitting member to reflect the light emitted from the light emitting member toward the plane of the light permeable lens.

5. The illuminating device in accordance with claim 1, further comprising a circuit board mounted in the main body and electrically connected to the light emitting member.

6. The illuminating device in accordance with claim 5, wherein the main body has a bottom formed with a recessed receiving portion to receive the circuit board.

7. The illuminating device in accordance with claim 6, wherein the circuit board is fully hidden in the receiving portion of the main body.

8. The illuminating device in accordance with claim 1, further comprising a retaining ring mounted on the main body and rested on the light permeable lens to retain the light permeable lens between the retaining ring and the main body.

9. The illuminating device in accordance with claim 8, wherein:
the main body has a first end formed with an outer thread;
the retaining ring has an inner wall formed with an inner thread screwed onto the outer thread of the main body so that the retaining ring is detachably mounted on the main body.

10. The illuminating device in accordance with claim 9, wherein the main body has a second end formed with an outer threading.

11. The illuminating device in accordance with claim 8, wherein the retaining ring has an end face formed with a radially and inwardly extending annular retaining flange rested on the light permeable lens so that the light permeable lens is detachably located between the retaining ring and the main body.

12. The illuminating device in accordance with claim 11, wherein:
the main body has a peripheral wall formed with an annular resting portion;
the light permeable lens has a periphery formed with a radially and outwardly extending annular limit flange clamped between the retaining flange of the retaining ring and the resting portion of the main body so that the light permeable lens is clamped between the retaining ring and the main body.

13. The illuminating device in accordance with claim 12, wherein the limit flange of the light permeable lens is located between the plane and the convex face.

14. The illuminating device in accordance with claim 12, wherein the resting portion of the main body is located at a top of the reflective face.

15. The illuminating device in accordance with claim 1, wherein the light permeable lens is detachably mounted on the main body.

16. The illuminating device in accordance with claim 1, wherein the light permeable lens is located in front of the light emitting member.

17. The illuminating device in accordance with claim 8, wherein the convex face of the light permeable lens protrudes outwardly from the retaining ring.

18. The illuminating device in accordance with claim 1, wherein the plane of the light permeable lens is located between the light emitting member and the convex face of the light permeable lens.

19. The illuminating device in accordance with claim 1, wherein the reflective face of the main body reflects the light emitted from the light emitting member toward the light permeable lens.

20. The illuminating device in accordance with claim 10, wherein the outer threading of the main body is screwed into a screw bore of a ceiling to attach the illuminating device to the ceiling.
